(19) United States
(12) Patent Application Publication
(10) Pub. No.: US 2024/0338156 A1
(43) Pub. Date: Oct. 10, 2024

(54) IMAGE FORMING APPARATUS, IMAGE FORMING METHOD, AND STORAGE MEDIUM

(71) Applicant: CANON KABUSHIKI KAISHA, Tokyo (JP)

(72) Inventor: YUUKI ARISAWA, Tokyo (JP)

(21) Appl. No.: 18/628,019

(22) Filed: Apr. 5, 2024

(30) Foreign Application Priority Data
Apr. 7, 2023 (JP) 2023-062888

(51) Int. Cl. G06F 3/12

(52) U.S. Cl. CPC G06F 3/1219; G06F 3/1251

(57) ABSTRACT

An image forming apparatus includes one or more memories and one or more processors. The one or more memories and the one or more processors are configured to control the image forming apparatus to perform printing of print data including a plurality of pieces of image data arranged in a direction orthogonal to a sheet conveyance direction; accept a cancel instruction for at least one piece of the plurality of pieces of the image data during the printing of the print data; and, in a case where a cancel instruction for first image data, of the image data, is accepted, control the printing of the print data to stop at an end position of second image data, of the image data, in the sheet conveyance direction of the print data, the second image data being image data not to be cancelled and being printed.

### BACKGROUND

### Field of the Disclosure

The present disclosure relates to an image forming apparatus, an image forming method, and a storage medium.

### Description of the Related Art

There are conventionally known image forming apparatuses, such as a printer and a copying machine, that temporarily store image data received from a host apparatus in a nonvolatile memory, such as a built-in hard disk, read the image data stored in the nonvolatile memory as appropriate, and print the image data. Among image forming apparatuses of this type are large format printers for printing image data on a large-sized sheet to print posters. Large format printers use roll paper as the sheet. Pieces of image data are usually printed in a row in the conveyance direction of the sheet. If the roll paper has a large sheet width with respect to the image data width, paper waste occurs. In this regard, there is a function called nesting printing, where a plurality of pieces of image data arranged in the main scanning direction of the sheet is printed. In nesting printing, the printer waits for the next image data to be received without printing until image data fills the sheet width in the main scanning direction. In nesting printing, each individual piece of image data received from a user can be cancelled during printing. Here, if the nesting printing itself is stopped, the output of image data that is included in the nesting printing and not intended to be cancelled also stops. To address this issue, there is known an image forming apparatus that continues to print until all image data included in nesting printing is cancelled. Japanese Patent Application Laid-Open No. 2018-126954 discusses an image forming apparatus that continues to print with image data to be cancelled masked.

If printing is continued until all image data included in nesting printing is cancelled, the printing of image data not intended to be cancelled will not be stopped. However, if the nesting printing includes a large number of pieces of image data, the sheet and ink can be wasted since ink discharge and sheet conveyance continue until all the image data is cancelled. According to Japanese Patent Application Laid-Open No. 2018-126954, image data to be cancelled is masked, reducing ink discharge to the cancelled print area. However, with a greater length of the image data to be cancelled in the sheet conveyance direction than that of the other image data, paper waste occurs.

### SUMMARY

Some embodiments of the present disclosure are directed to, in printing a plurality of images arranged in the direction orthogonal to the sheet conveyance direction, reducing sheet and ink consumption while preventing printing of images not to be cancelled from being interrupted if any of the images is cancelled in the middle.

According to an aspect of the present disclosure, an image forming apparatus includes one or more memories and one or more processors. The one or more memories and the one or more processors are configured to control the image forming apparatus to perform printing of print data including a plurality of pieces of image data arranged in a direction orthogonal to a sheet conveyance direction, accept a cancel instruction for at least one piece of the plurality of pieces of the image data during the printing of the print data, and, in a case where a cancel instruction for first image data, of the image data, is accepted, control the printing of the print data to stop at an end position of second image data, of the image data, in the sheet conveyance direction of the print data, the second image data being image data not to be cancelled and being printed.

Further features of various embodiments of the present disclosure will become apparent from the following description of exemplary embodiments with reference to the attached drawings.

### BRIEF DESCRIPTION OF THE DRAWINGS

FIG. 1 is a diagram illustrating a general configuration example of an image forming system.

FIG. 2 is a flowchart illustrating processing performed by an image forming apparatus.

FIGS. 3A to 3E are charts illustrating examples of an image data management table.

FIG. 4 is a diagram schematically illustrating pieces of image data laid out on a sheet.

FIG. 5 is a flowchart illustrating details of print processing according to a first exemplary embodiment.

FIGS. 6A to 6D are charts illustrating examples of an image data management table.

FIG. 7 is a flowchart illustrating details of user interface (UI) processing according to a second exemplary embodiment.

FIGS. 8A to 8D are charts illustrating examples of an image data management table.

FIG. 9 is a diagram schematically illustrating pieces of image data laid out on a sheet.

FIG. 10 is a flowchart illustrating details of print processing according to a third exemplary embodiment.

FIG. 11 is a diagram schematically illustrating pieces of image data laid out on a sheet.

FIGS. 12A to 12F are charts illustrating examples of an image data management table.

FIG. 13 is a diagram schematically illustrating pieces of image data laid out on a sheet.

### DESCRIPTION OF THE EMBODIMENTS

Exemplary embodiments will be described in detail below with reference to the attached drawings. The following exemplary embodiments are not intended to limit the claims. While in the exemplary embodiments, a plurality of features is described, not all the features are used in every embodiment, and more than one of the features may be freely combined. In the attached drawings, like numbers refer to like components, and a redundant description thereof will be omitted.

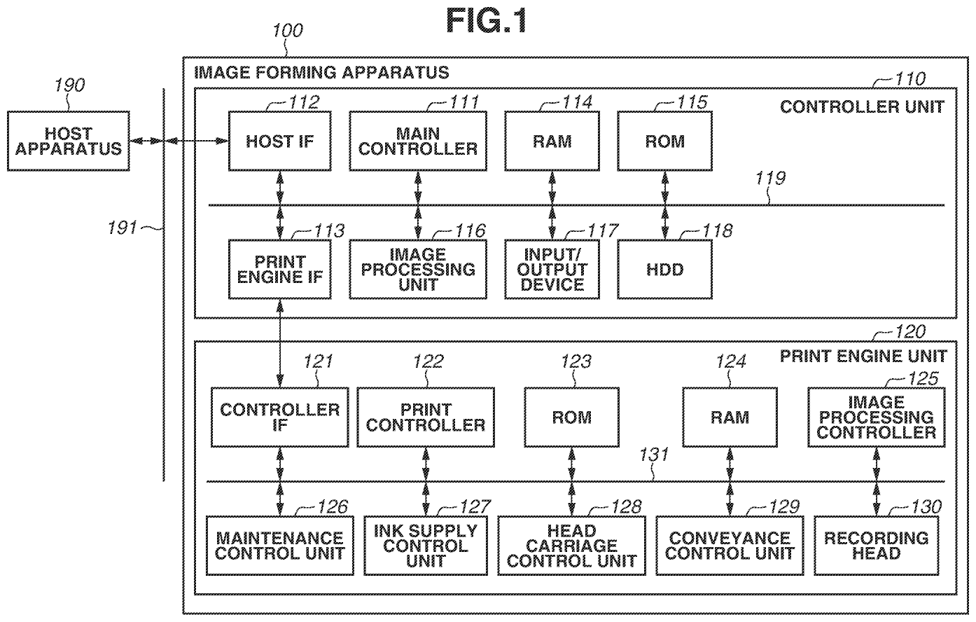

FIG. 1 is a diagram illustrating a general configuration example of an image forming system according to a first exemplary embodiment. As illustrated in FIG. 1, the image forming system includes a host apparatus 190 and an image forming apparatus 100, which are connected to a network 191. The image forming apparatus 100 can communicate with the host apparatus 190 via the network 191. The host apparatus 190 is an information processing apparatus, such as a personal computer (PC) operated by a user, and a printer driver is installed thereon. The host apparatus 190 transmits image data and various instructions including a print instruction for the image data to the image forming apparatus 100 via the network 191. The host apparatus 190 may be any external apparatus serving as a source of image data. Examples may include an image reader, a digital camera, and a smartphone. The network 191 may be any network, such as a wired communication network, a wireless communication network, and one including both. A plurality of host apparatuses 190 may be connected to the network 191.

The image forming apparatus 100 sequentially stores received pieces of image data inside, generates a piece of image data by arranging the stored plurality of pieces of image data in the direction orthogonal to a conveyance direction of a sheet (hereinafter, referred to as the main scanning direction of the sheet), and prints the generated image data. Such printing will hereinafter be referred to as nesting printing.

The image forming apparatus 100 includes a controller unit 110 and a print engine unit 120. The controller unit 110 includes a main controller 111, a host interface (IF) 112, a print engine IF 113, a random-access memory (RAM) 114, a read-only memory (ROM) 115, an image processing unit 116, an input/output device 117, and a hard disk drive (HDD) 118. These components are connected via a system bus 119.

The main controller 111 includes a central processing unit (CPU), and controls the operation of the entire image forming apparatus 100. Various types of processing illustrated in flowcharts to be described below are performed by the main controller 111 reading and executing programs stored in the ROM 115.

The host IF 112 is connected to the network 191, and transmits and receives information to/from external apparatuses, such as the host apparatus 190, via the network 191 under the control of the main controller 111.

The print engine IF 113 is connected to a controller IF 121 of the print engine unit 120, and exchanges information with the print engine unit 120 under the control of the main controller 111.

The RAM 114 is used as a work area of the main controller 111. The RAM 114 also temporarily stores image data received from external apparatuses, such as the host apparatus 190, and various types of setting data.

The ROM 115 stores programs for the main controller 111 to execute and stores various types of data used for various operations of the image forming apparatus 100.

The image processing unit 116 applies various types of image processing to image data. The image processing unit 116 performs processing of rendering (converting) image data expressed in a page description language into bitmap image data. The image processing unit 116 also performs processing of converting the color space of the image data (such as YCbCr) into a standard red, green, blue (RGB) color space (such as standard RGB [sRGB]). The image processing unit 116 also performs various types of image processing as appropriate. Examples include resolution conversion into an effective number of pixels (printable by the image forming apparatus 100), image analysis, image correction, and generation of a piece of image data by combining a plurality of pieces of image data. The image data obtained by such image processing is stored in the RAM 114.

The image forming apparatus 100 receives image data from the host apparatus 190 via the host IF 112, and applies predetermined image processing to the received image data using the image processing unit 116 under the control of the main controller 111. The image forming apparatus 100 then provides the processed image data to the print engine unit 120 via the print engine IF 113 under the control of the main controller 111.

The input/output device 117 includes an input unit for the user to make various operations to input information, such as hardware keys and a touchscreen, and a display unit for displaying (notifying) various types of information to the user, such as a display. The input/output device 117 may be configured to implement the information notification to the user by outputting sound (such as a buzzer sound and voice) based on sound information from a sound generator.

The HDD 118 is a nonvolatile storage area. Programs for the main controller 111 to execute, image data, and setting data used for various operations of the image forming apparatus 100 can be stored in and read from the HDD 118. Other mass storage devices, such as a flash memory, may be used instead of the HDD 118.

The print engine unit 120 is a printing unit for performing image formation. The print engine unit 120 includes the controller IF 121, a print controller 122, a ROM 123, a RAM 124, and an image processing controller 125. The print engine unit 120 further includes a maintenance control unit 126, an ink supply control unit 127, a head carriage control unit 128, a conveyance control unit 129, and a recording head 130. These components are connected via a system bus 131.

The print controller 122 includes a CPU, and controls various mechanisms of the print engine unit 120 based on programs and various parameters stored in the ROM 123, using the RAM 124 as a work area.

The controller IF 121 is connected to the print engine IF 113 of the controller unit 110, and exchanges information with the controller unit 110. When the print controller 122 accepts various commands and image data from the controller unit 110 via the controller IF 121, the print controller 122 temporarily stores the commands and image data into the RAM 124.

The print controller 122 converts the image data stored in the RAM 124 into print data so that the recording head 130 can use the data for a recording operation, using the image processing controller 125.

With the print data generated, the print controller 122 causes the recording head 130 to perform a recording operation based on the print data. The print controller 122 requests the conveyance control unit 129 to convey a sheet. The conveyance control unit 129 controls a conveyance mechanism for conveying the printing sheet under the control of the print controller 122. The recording head 130 performs the recording operation in synchronization with the sheet conveyance operation based on instructions from the print controller 122, whereby print processing is performed. The head carriage control unit 128 controls the direction and position of the recording head 130 based on operating states of the image forming apparatus 100, such as a maintenance state and a recording state. The ink supply control unit 127 controls the pressure of ink supplied to the recording head 130 within an appropriate range. The maintenance control unit 126 controls cleaning of conveyance rollers for conveying the printing sheet and the recording head 130.

The recording head 130 is a printing unit for printing images. The recording head 130 prints an image on the sheet based on print data. For example, the recording head 130 includes a plurality of print heads of respective colors, and forms an image on the sheet by discharging ink in synchronization with the conveyance of the sheet. While the image forming apparatus 100 according to the present exemplary embodiment is described by taking as an example an inkjet printer that uses ink as a recording material, this is not restrictive. The present exemplary embodiment is also applicable to image forming apparatuses of other printing methods, including a thermal printer (sublimation or thermal transfer printer), a dot impact printer, and an electrophotographic printer, such as a light-emitting diode (LED) printer and a laser printer. In the present exemplary embodiment, a roll of a sheet of paper, or a rolled recording medium (roll paper), is assumed to be used. However, an unrolled recording medium may be used.

In the present exemplary embodiment, the input/output device 117 is included in the image forming apparatus 100. However, this is not restrictive. For example, the input/output device 117 may be an external device connected via the network 191. The host apparatus 190 may serve as the input/output device 117. The image forming apparatus 100 may be further connected with other input/output devices via the network 191 in addition to the input/output device 117.

In the present exemplary embodiment, the image data is temporarily stored in the RAMs 114 and 124. However, the image data may be temporarily stored in a nonvolatile device, such as an HDD.

A program for implementing the functions of the present exemplary embodiment may be supplied to a system or an apparatus via a network or various storage media. A computer (such as a CPU and a microprocessing unit [MPU]) of the system or apparatus may read the program to perform the functions, or cause various mechanisms to perform the functions. The program may be executed by a single computer or through cooperation of a plurality of computers. The various types of processing do not need to be all implemented with software, and part or all of the processing may be implemented with hardware, such as an application-specific integrated circuit (ASIC). All the processing does not necessarily need to be performed by a single CPU, and may be performed by a plurality of CPUs in a cooperative manner as appropriate. Part of the processing may be performed by a single CPU, and the rest of the processing may be cooperatively performed by a plurality of CPUs.

Next, an example of a processing procedure performed by the image forming apparatus 100 according to the present exemplary embodiment will be described. The present exemplary embodiment deals with a case where a cancel instruction is accepted for a piece of image data among a plurality of pieces of image data to be printed during nesting printing. In the following description, suppose the cancel instruction is given for a piece of image data having the largest image data length (hereinafter, referred to as image height) in the sheet conveyance direction of the print data among the pieces of image data to be nesting printed.

In the present exemplary embodiment, in combining a plurality of pieces of image data to be nesting printed to generate combined data, the plurality of pieces of image data is arranged so that their respective start positions are all aligned to the start position of the combined data in the sheet conveyance direction. In other words, the image height of each piece of image data agrees with the end position of the image data in the sheet conveyance direction of the combined data. The greater the image height is, the farther back the end position is in the sheet conveyance direction of the combined data.

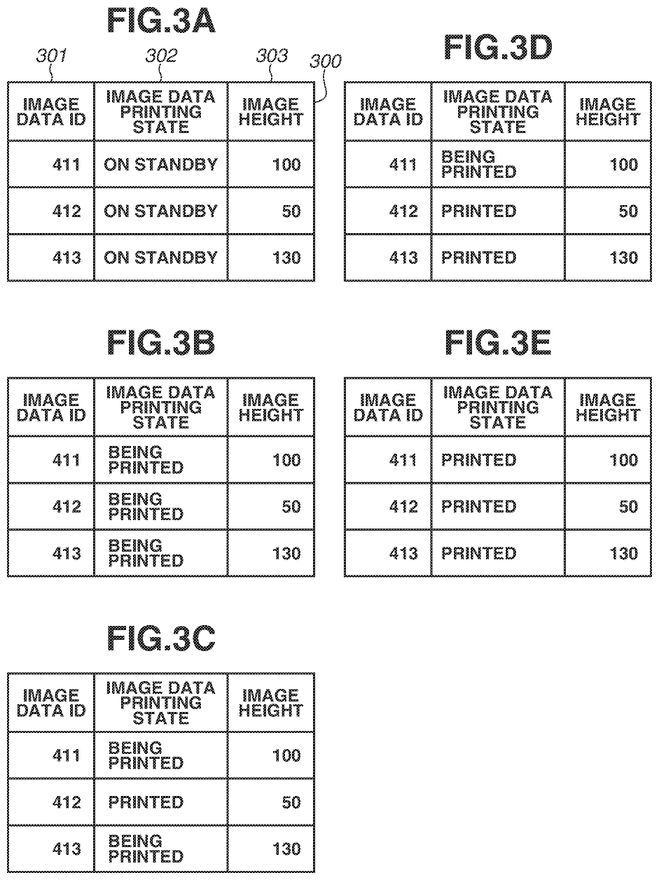

FIGS. 3A to 3E illustrate examples of an image data management table according to the present exemplary embodiment. An image data management table 300 is stored in the RAM 114. The image data management table 300 stores information about an image data printing state (which hereinafter may be referred to simply as a printing state) 302 and information about an image height 303 of image data, linked with an image data identifier (ID) 301. The image data ID 301 is identification information for identifying image data. The image data printing state 302 indicates a printing state whether the image data is on standby for printing, being printed, or printed. In an initial state, “on standby” is registered in the image data printing state 302. The main controller 111 manages the printing state and the image height of each piece of image data to be nesting printed, using the image data management table 300. The main controller 111 is an example of a management unit.

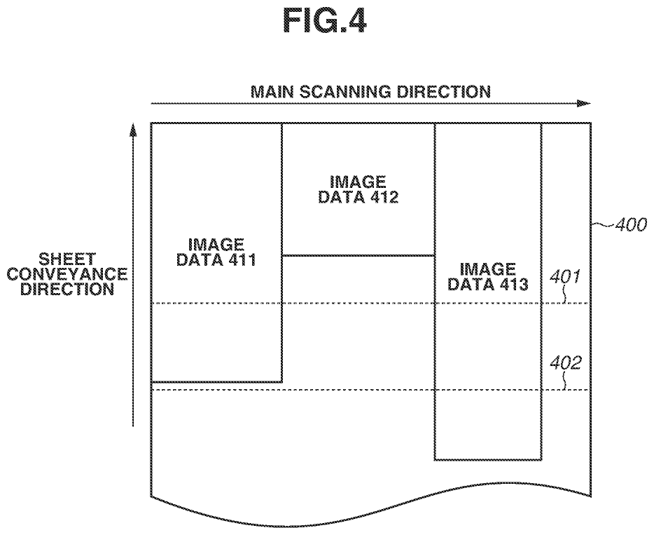

FIG. 4 is a diagram schematically illustrating pieces of image data laid out on a sheet. In the following description, suppose that pieces of image data 411, 412, and 413 are sequentially received from the host apparatus 190 within a predetermined time, arranged on a sheet 400 in the main scanning direction, and printed by nesting printing. Suppose also that a cancel instruction for the image data 413 is accepted when the nesting printing is completed up to a position 401.

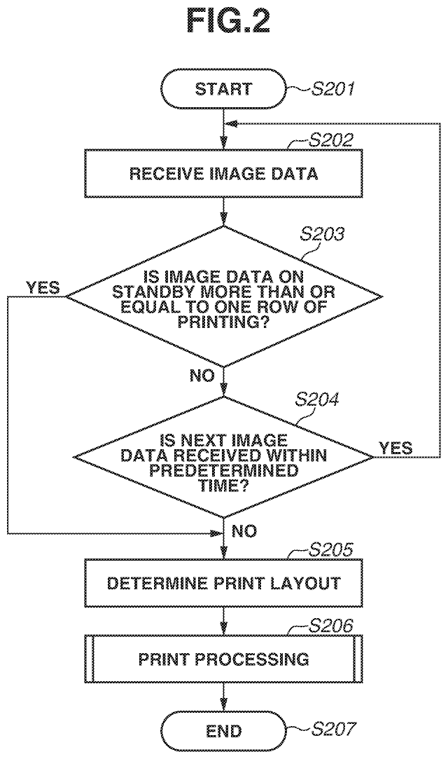

FIG. 2 is a flowchart illustrating a general procedure from when the image forming apparatus 100 according to the present exemplary embodiment receives image data from the host apparatus 190, to when the image forming apparatus 100 performs print processing. The processing of this flowchart is implemented by the main controller 111 loading a program stored in the ROM 115 into the RAM 114 and executing the program.

In step S201, the main controller 111, which is ready to receive image data from the host apparatus 190, starts the processing of this flowchart.

In step S202, the main controller 111 receives image data from the host apparatus 190 via the host IF 112, stores the received image data in the RAM 114, and registers information about the received image data in the image data management table 300. Suppose here that the main controller 111 receives the image data 411, stores the image data 411 in the RAM 114, and registers information about the image data 411 in the first row of the image data management table 300.

In step S203, the main controller 111 determines whether image data stored in the RAM 114 (image data on standby for printing) is more than or equal to one row of printing. One row of printing refers to a length corresponding to the width of the set sheet in the main scanning direction. The main controller 111 adds the image widths of pieces of image data stored in the RAM 114, and determines whether the total length is greater than or equal to one row of printing. If the total length is determined to be greater than or equal to one row of printing (YES in step S203), the processing proceeds to step S205. If the total length is determined to be less than one row of printing (NO in step S203), the processing proceeds to step S204.

In the example of FIG. 4, the image data 411 has an image width sufficiently smaller than the width of the sheet 400 in the main scanning direction. When the image data 411 is received, the stored image data is thus determined to not be more than or equal to one row of printing. The processing proceeds to step S204.

In step S204, the main controller 111 waits for reception of the next image data for a predetermined time. The waiting time is stored in the ROM 115 as a parameter. If the next image data is received within the predetermined time (YES in step S204), the processing proceeds to step S202. If the predetermined time elapses before the next image data is received (NO in step S204), the processing proceeds to step S205. Suppose here that after the reception of the image data 411, the image data 412 and 413 are received and stored in the RAM 114, and the information about the image data 412 and 413 is registered in the second and third rows of the image data management table 300. The predetermined time then elapses before reception of the next image data, and the processing proceeds to step S205.

In step S205, the main controller 111 determines the print layout of the image data 411, 412, and 413 stored in the RAM 114, and generates print data. Specifically, the main controller 111 applies predetermined image processing to the image data 411, 412, and 413 stored in the RAM 114 and generates combined data where the pieces of image data 411, 412, and 413 are arranged in the main scanning direction of the sheet, using the image processing unit 116. The combined data on the image data 411, 412, and 413 is stored in the RAM 114. The main controller 111 requests the print controller 122 to print the combined data on the image data 411, 412, and 413 via the print engine IF 113 and the controller IF 121. The print controller 122 stores the combined data on the image data 411, 412, and 413 provided by the controller unit 110 into the RAM 124. The print controller 122 converts the stored combined data into print data using the image processing controller 125, so that the recording head 130 can use the data for a recording operation.

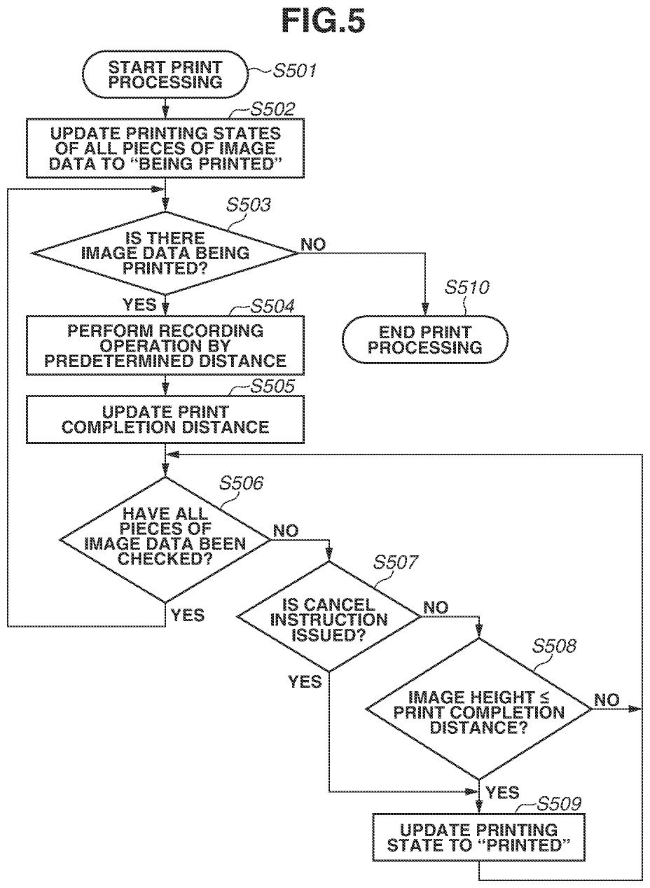

In step S206, the main controller 111 refers to the image data management table 300 stored in the RAM 114, and prints the image data 411, 412, and 413. The processing then proceeds to step S207. In step S206, the main controller 111 performs print processing based on the print data generated in step S205, in cooperation with the print controller 122. Details of the print processing performed in this step will be described below with reference to FIG. 5. The main controller 111 is an example of a print control unit.

After the end of the print processing of step S206, then in step S207, the processing of this flowchart ends.

FIG. 5 is a flowchart illustrating a detailed example of the print processing of step S206 in FIG. 2.

With the print layout determined in step S205 of FIG. 2, then in step S501, the main controller 111 starts the print processing of the print data. The image data management table 300 of FIG. 3A illustrates the printing states of the image data 411, 412, and 413 immediately before the start of printing. The printing states 302 of the image data 411, 412, and 413 are all “on standby”.

In step S502, the main controller 111 updates the printing states 302 of the image data on standby to “being printed”. Since the start position of the print data agrees with the start positions of the image data 411, 412, and 413, the image data printing states 302 of the image data 411, 412, and 413 are updated to “being printed”. FIG. 3B illustrates the image data management table 300 updated from the state of FIG. 3A. The main controller 111 stores the print-completed length of the print data (hereinafter, referred to as a print completion distance) in the RAM 114. A print completion distance of 0 is stored in the initial state. The print controller 122 causes the conveyance control unit 129 to convey the sheet.

In step S503, the main controller 111 checks the printing states 302 of all the pieces of image data and determines whether there is image data being printed. If there is image data being printed (YES in step S503), the processing proceeds to step S504. If there is no print data being printed (NO in step S503), the processing proceeds to step S510. In the state of FIG. 3B, the printing states 302 of the image data 411, 412, and 413 are all “being printed”. The processing therefore proceeds to step S504. In the states of FIGS. 3C and 3D to be described below, the processing also proceeds to step S504 since there is image data being printed. The main controller 111 thus continues the entire nesting printing as long as there is image data being printed.

In step S504, the print controller 122 causes the recording head 130 to perform a recording operation based on the print data by a predetermined distance in synchronization with the conveyance. After the completion of the recording operation by the predetermined distance, the processing proceeds to step S505. Here, the recording operation will be performed in units of 10 lines.

In step S505, the main controller 111 updates the print completion distance stored in the RAM 114. In the case of performing the recording operation in units of 10 lines, the print completion distance is updated to 10 by the first update. The main controller 111 thereafter updates the print completion distance by adding 10 each time step S504 is performed.

In step S506, the main controller 111 checks whether to update the printing state 302 of each of the pieces of image data. If all the pieces of image data have been checked (YES in step S506), the processing proceeds to step S503. If there is an unchecked piece of image data (NO in step S506), the processing proceeds to step S507. In the state of FIG. 3B, the processing proceeds to step S507 to check whether to update the printing states 302 of the image data 411, 412, and 413.

In step S507, the main controller 111 determines whether a cancel instruction for target image data is given, with a piece of image data of which whether to update the printing state 302 is yet to be checked as the target image data. The main controller 111 accepts a cancel instruction for image data while performing the print processing. The main controller 111 is an example of an acceptance unit. The cancel instruction for image data may be input from the input/output device 117 with the image data specified by user operation, or transmitted from the host apparatus 190 of the user that gives the image data. If a cancel instruction for the target image data is determined to be given (YES in step S507), the processing proceeds to step S509. If no cancel instruction is determined to be given (NO in step S507), the processing proceeds to step S508. Since the current print completion distance is 10 and a cancel instruction for the image data 413 is assumed to be given when the print completion distance is 70, the processing proceeds to step S508.

In step S508, the main controller 111 compares the image height 303 of the target image data with the current print completion distance stored in the RAM 114. If the print completion distance is greater than or equal to the image height 303 of the target image data (YES in step S508), the processing proceeds to step S509. If the print completion distance is less than the image height 303 of the target image data (NO in step S508), the processing proceeds to step S506.

When the print completion distance is 10, the image data management table 300 is in the state of FIG. 3B and there is no cancel instruction for the image data 411, 412, or 413. Moreover, a print completion distance of 10 is less than the image height 303 of any of the pieces of image data 411, 412, and 413. The main controller 111 checks that the printing state 302 does not need to be updated, with the pieces of image data 411, 412, and 413 as the target image data in succession, and the processing returns to step S503 without updating the image data management table 300 from the state of FIG. 3B.

Suppose that the recording operation is then performed in units of the predetermined distance in step S504 and the print completion distance is updated to 20, 30, and 40 in step S505. When the print completion distance is 20, 30, or 40, there is no cancel instruction for the image data 411, 412, or 413. Moreover, the print completion distances of 20, 30, and 40 are less than the image height 303 of any of the pieces of image data 411, 412, and 413. The image data management table 300 thus remains in the state of FIG. 3B.

Suppose that the print completion distance is then updated to 50 in step S505. Since the image height 303 of the image data 412 is 50 and agrees with the print completion distance, the processing transitions from step S508 to step S509 when the image data 412 is checked.

In step S509, the main controller 111 updates the printing state 302 of the image data 412 to “printed”. The processing proceeds to step S506. FIG. 3C illustrates the image data management table 300 updated from the state of FIG. 3B.

Suppose that the cancel instruction for the image data 413 is then given when the print completion distance is 70. In such a case, the processing transitions from step S507 to step S509 when the image data 413 is checked.

In step S509, the main controller 111 updates the printing state 302 of the image data 413 to “printed”. The processing proceeds to step S506. FIG. 3D illustrates the image data management table 300 updated from the state of FIG. 3C. If a cancel instruction for image data is given, the main controller 111 thus updates the printing state 302 of the image data to be cancelled to “printed”. The updated state is not limited to “printed” and may be any state other than “being printed”, like “cancelled”.

Suppose that the print completion distance is subsequently updated to 100 in step S505. Since the image height 303 of the image data 411 is 100 and agrees with the print completion distance, the processing transitions from step S508 to step S509 when the image data 411 is checked.

In step S509, the main controller 111 updates the printing state 302 of the image data 411 to “printed”. The processing proceeds to step S506. FIG. 3E illustrates the image data management table 300 updated from the state of FIG. 3D.

The image data 412 and 413 is then checked, and the processing proceeds to step S503.

In step S503, the main controller 111 determines that there is no image data being printed, since the printing states 302 of the image data 411, 412, and 413 are all “printed” in the state of FIG. 3E. The processing proceeds to step S510 to stop the nesting printing. In such a manner, the main controller 111 controls the nesting printing to stop when the print completion distance reaches the image height 303 of the image data 411. The image height 303 on the image data 411 is an example of the end position of image data not to be cancelled and being printed in the sheet conveyance direction of the print data. There is a plurality of pieces of print data not to be cancelled, namely, the image data 411 and 412. The main controller 111 continues the nesting printing after the printing state 302 of the image data 412 is updated to “printed” since the printing state 302 of the image data 411 is “being printed”. The main controller 111 thus controls the nesting printing to stop when the print completion distance reaches the image height 303 of the image data 411 having the maximum image height among the pieces of image data not to be cancelled. As a result, if a cancel instruction is given for the image data 413 having the maximum image height among the pieces of image data to be nesting printed, the nesting printing can be stopped before the end position of the image data 413. The printing stop position here is a position 402 of FIG. 4.

In step S510, the print controller 122 causes the conveyance control unit 129 to stop conveying the sheet. The main controller 111 then ends the print processing. The processing proceeds to step S207.

In the present exemplary embodiment described above, if a cancel instruction is given for image data included in the nesting printing, the nesting printing can be stopped at the end position of image data not to be cancelled and being printed. The nesting printing can thus be stopped before the end position of the image data to be cancelled without interrupting the printing of the image data not to be cancelled. In other words, paper and ink waste can be prevented.

If there is image data of which the printing state 302 is “on standby” in step S510, the main controller 111 may continue sheet conveyance and print continuously instead of stopping the print processing.

The main controller 111 may determine a print end position from the image data management table 300 in advance when starting printing, and control the update of the determined print end position if a cancel instruction is given. Specifically, when starting printing, the main controller 111 initially determines the image height 303 of the image data 413 having the maximum image height, or 130, as the print end position. If a cancel instruction for the image data 413 is given, the main controller 111 then updates the print end position with the image height 303 of the image data 411 having the maximum image height among the pieces of image data not to be cancelled. In such a case, the main controller 111 controls the nesting printing to stop if the print completion distance reaches or exceeds the print end position.

A second exemplary embodiment deals with a case where when a user issues a cancel instruction for image data, the user that has issued the cancel instruction and a user or users that has or have given image data being printed in the nesting printing are notified. Differences from the first exemplary embodiment will be mainly described below, and a description of similarities will be omitted.

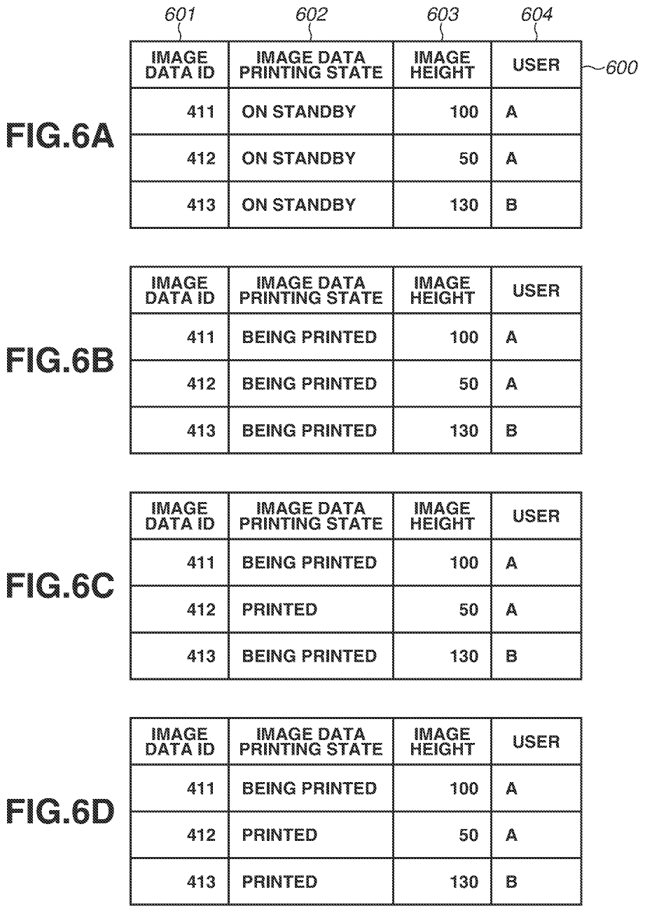

FIGS. 6A to 6D illustrate examples of an image data management table according to the present exemplary embodiment. An image data management table 600 according to the present exemplary embodiment includes items 601, 602, and 603, which correspond to the items 301, 302, and 303 of the image data management table 300 of FIG. 3, respectively. The image data management table 600 according to the present exemplary embodiment is different from the image data management table 300 of FIG. 3 in that an item “user 604” is included. The user 604 indicates information about users that have given respective pieces of image data. The main controller 111 determines a user that has logged in to the host apparatus 190 that has transmitted image data received in step S202 of FIG. 2 to be the user that has given the image data. Image data selected from pieces of image data stored in the HDD 118 by user operation on the input unit of the input/output device 117 may be handled the same as image data received from the host apparatus 190. In such a case, the main controller 111 determines the user of the image forming apparatus 100 to be the user that has given the image data.

In the present exemplary embodiment, suppose, as with the first exemplary embodiment, that the pieces of image data 411, 412, and 413 are sequentially received from the host apparatus 190 within a predetermined time, arranged on the sheet 400 in the main scanning direction, and printed by nesting printing. The image data 411 and 412 is given by user A. The image data 413 is given by user B. FIG. 6A corresponds to the state of FIG. 3A. FIG. 6B corresponds to the state of FIG. 3B. FIG. 6C corresponds to the state of FIG. 3C. FIG. 6D corresponds to the state of FIG. 3D. The main controller 111 manages the printing state and image height of each piece of image data to be nesting printed and the user that has given the image data, using the image data management table 600.

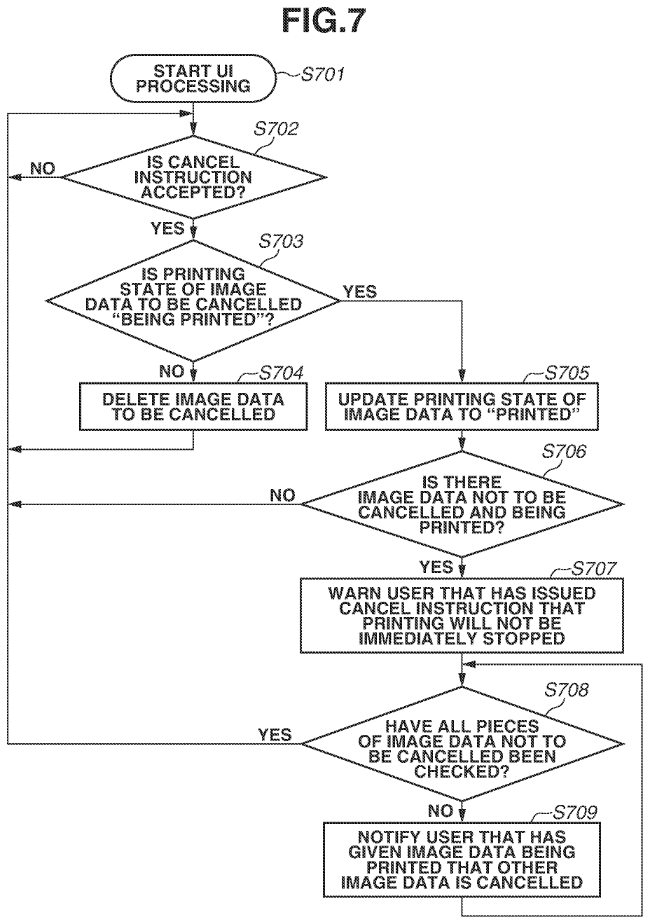

FIG. 7 is a flowchart illustrating a detailed example of user interface (UI) processing performed by the image forming apparatus 100 according to the present exemplary embodiment. The UI processing is processing performed in parallel with the print processing of FIG. 5. In the present exemplary embodiment, suppose, as with first exemplary embodiment, that a cancel instruction for the image data 413 is issued when the print completion distance is 70.

In step S701, in response to when the print processing of FIG. 5 is started, the main controller 111 starts the UI processing.

In step S702, the main controller 111 waits for a cancel instruction for image data from a user while performing the print processing. The main controller 111 waits until a cancel instruction for image data is accepted. If a cancel instruction for image data is accepted (YES in step S702), the processing proceeds to step S703. Specifically, the main controller 111 checks whether a cancel instruction is received from the host apparatus 190 and whether a cancel instruction for image data is input by user operation via the input unit of the input/output device 117. In this example, a cancel instruction for the image data 413 is accepted, and the processing proceeds to step S703.

In step S703, the main controller 111 checks whether the printing state 602 of the image data to be cancelled is “being printed”. If the printing state 602 is “being printed” (YES in step S703), the processing proceeds to step S705. If the printing state 602 is “printed” or “on standby” (NO in step S703), the processing proceeds to step S704. In this example, as illustrated in FIG. 6C, the printing state 602 of the image data 413 to be cancelled is “being printed” when the print completion distance is 70. The processing thus proceeds to step S705.

In step S704, the main controller 111 deletes the image data to be cancelled from the image data management table 600. The processing proceeds to step S702.

In step S705, the main controller 111 updates the printing state 602 of the image data to be canceled to “printed”. The processing proceeds to step S706. In this example, the printing state 602 of the image data 413 to be cancelled is updated to “printed”, and the image data management table 600 changes from the state of FIG. 6C to that of FIG. 6D. This step may be performed during the print processing of FIG. 5.

In step S706, the main controller 111 checks whether the printing state 602 of each piece of image data not to be cancelled is “being printed”. If there is image data being printed among the pieces of image data not to be cancelled (YES in step S706), the processing proceeds to step S707. If there is no image data being printed (NO in step S706), the processing proceeds to step S702. In this example, with the image data management table 600 in the state of FIG. 6D, the main controller 111 checks the printing states 602 of the image data 411 and 412 other than the image data 413 to be cancelled. Since the printing state 602 of the image data 411 is “being printed”, the processing proceeds to step S707.

If the processing proceeds from step S706 to step S707, the nesting printing continues since image data other than the image data 413 to be cancelled is being printed. In step S707, the main controller 111 therefore warns (notifies) the user that issued the cancel instruction that the printing will not be immediately stopped. The processing proceeds to step S708. If the cancel instruction is transmitted from the host apparatus 190, the main controller 111 may display a warning message on the operation screen of the user that has logged in to the transmitting host apparatus 190. If the cancel instruction is input via the input unit of the input/output device 117, the main controller 111 may display a warning message on the display unit of the input/output device 117 or output warning sound information.

In this example, if that user B issues the cancel instruction for the image data 413, user B is warned that the printing will not be immediately stopped. However, the user that has issued a cancel instruction for image data and the user that has given the image data (user 604 of FIG. 6) can be different in some cases, like when user A issues a cancel instruction for the image data 413. In such a case, user B that has given the image data 413 may be warned instead of user A that has issued the cancel instruction for the image data 413. Alternatively, the user that has issued a cancel instruction for image data and the user that has given the image data may be both warned. The warning processing here is an example of notification control processing for issuing a notification that the printing will not be immediately stopped.

In step S708, the main controller 111 checks whether the printing state 602 of image data not to be cancelled is “being printed”. If there is an unchecked piece of image data (NO in step S708), the processing proceeds to step S709. If all the pieces of image data not to be cancelled have been checked (YES in step S708), the processing proceeds to step S702. In this example, the processing proceeds to step S709 since the image data management table 600 is in the state of FIG. 6D and the printing state 602 of the image data 411 is “being printed”.

In step S709, the main controller 111 notifies the user that has given the image data of which the printing state 602 is “being printed” that other image data is cancelled. The processing proceeds to step S708. In this example, the printing state 602 of the image data 411 is “being printed”, and the notification that other image data is cancelled is transmitted to the host apparatus 190 to which the user 604 of the image data 411, or user A, has logged in. The notification processing here is an example of notification control processing for issuing a notification that a cancel instruction for other image data is issued. This can prompt the notified user to issue a cancel instruction for the image data being printed. More specifically, the cancel instruction for other image data can be issued because the supply of consumables, such as the sheets and ink, is low. If a cancel instruction for image data being printed is issued to replace consumables, the users of image data being simultaneously printed can be prompted to cancel the image data.

In the present exemplary embodiment described above, the image forming apparatus 100, if image data not to be cancelled is being printed, warns the user that has issued a cancel instruction that the printing will not be immediately stopped. The user that has issued the cancel instruction for image data can thus find out the situation where the nesting printing is unable to be immediately stopped. The image forming apparatus 100 also notifies the user or users that has or have given image data not to be cancelled of the cancellation of other image data. This can prompt the user or users that has or have given the image data included in the same nesting printing as the image data to be cancelled to determine whether to issue a cancel instruction.

In step S705, the main controller 111 may update the printing state 602 of the image data to be cancelled to “cancelled” for the sake of distinction from “printed”.

A third exemplary embodiment deals with a case where pieces of image data are laid out for nesting printing not by aligning their start positions in the sheet conveyance direction but by aligning their end positions in the direction opposite to the sheet conveyance direction (bottom alignment). Differences from the first exemplary embodiment will be mainly described, and a description of similarities will be omitted.

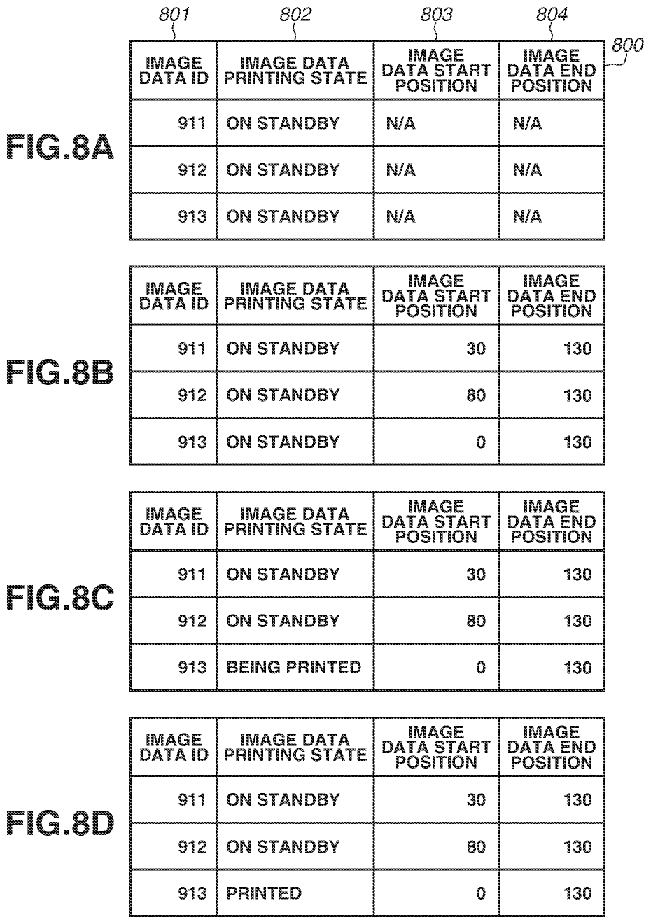

FIGS. 8A to 8D illustrate examples of an image data management table according to the present exemplary embodiment. Items 801 and 802 of an image data management table 800 according to the present exemplary embodiment correspond to the items 301 and 302 of the image data management table 300 of FIG. 3, respectively. The image data management table 800 according to the present exemplary embodiment is different from the image data management table 300 of FIG. 3 in that items “image data start position 803” and “image data end position 804” are included instead of the item “image height 303”. The image data start position (which hereinafter may be referred to simply as a start position) 803 indicates information about the start position of image data in the sheet conveyance direction of the print data. The image data end position (which hereinafter may be referred to simply as an end position) 804 indicates information about the end position of image data in the sheet conveyance direction of the print data. The main controller 111 manages the printing state, start position, and end position of each piece of image data to be nesting printed, using the image data management table 800. The main controller 111 is an example of a management unit.

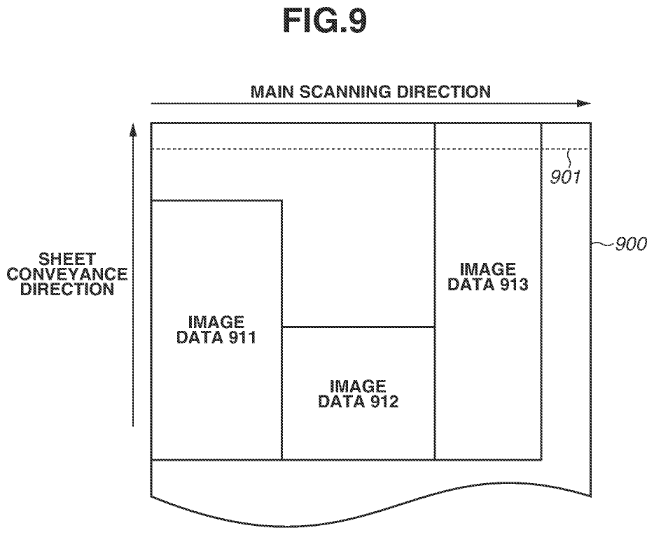

FIG. 9 is a diagram schematically illustrating pieces of image data laid out on a sheet. In the following description, suppose that pieces of image data 911, 912, and 913 are sequentially received from the host apparatus 190 within a predetermined time, arranged on a sheet 900 in the main scanning direction, and printed by nesting printing. Suppose also that a cancel instruction for the image data 913 is accepted when the nesting printing is completed up to a position 901.

As with the first exemplary embodiment, the nesting printing according to the present exemplary embodiment is performed along with the flowchart of FIG. 2. The image data management table 800 of FIG. 8A illustrates a state before the print layout is determined in step S205. As illustrated in FIG. 8A, the information about the image data start position 803 and the information about the image data end position 804 are not set until the print layout is determined. FIG. 8B illustrates the state of the image data management table 800 after the print layout is determined in step S205. In FIG. 8B, as the image data start position 803 and the image data end position 804, information based on the print layout is stored. Step S206 is then performed. In the present exemplary embodiment, the print processing performed in step S206 is different from that of the first exemplary embodiment.

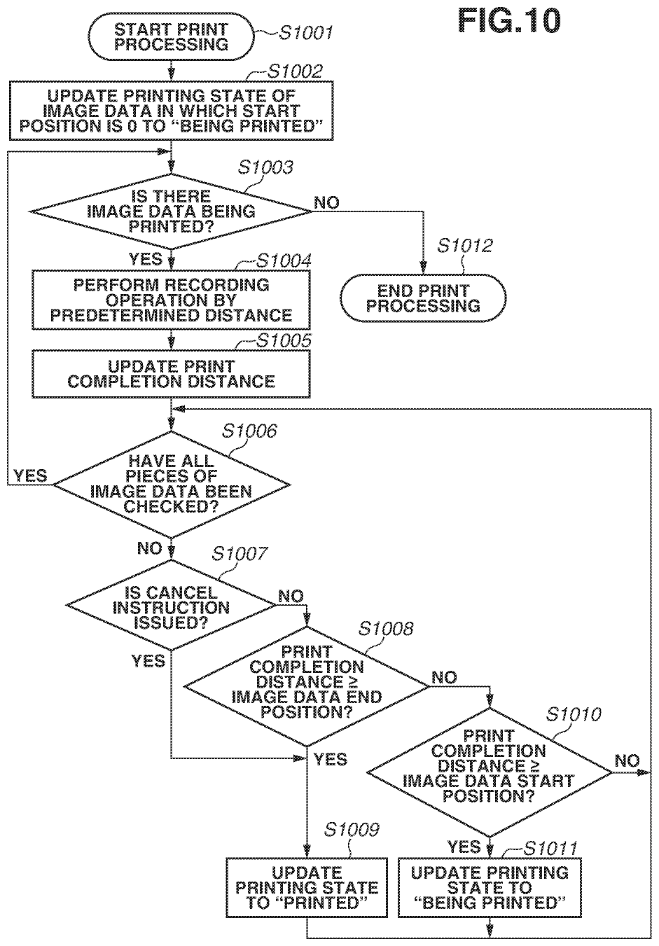

FIG. 10 is a flowchart illustrating a detailed example of the print processing in step S206.

In step S1001, with the print layout determined in step S205 of FIG. 2, the main controller 111 starts the print processing of the print data. The image data management table 800 of FIG. 8B illustrates the printing states 802 of the image data 911, 912, and 913 immediately before the start of printing. The printing states 802 of the image data 911, 912, and 913 are all “on standby”.

In step S1002, the main controller 111 updates the printing state 802 of image data of which the image data start position 803 has a value of 0 to “being printed”. Here, the start position 803 of the image data 913 is 0, and the main controller 111 updates the printing state 802 of the image data 913 to “being printed”. FIG. 8C illustrates the image data management table 800 updated from the state of FIG. 8B. The main controller 111 stores the print completion distance in the RAM 114. A print completion distance of 0 is stored in the initial state. The print controller 122 causes the conveyance control unit 129 to convey the sheet.

In step S1003, the main controller 111 checks the printing state 802 of each piece of image data, and determines whether there is print data being printed. If there is image data being printed (YES in step S1003), the processing proceeds to step S1004. If there is no image data being printed (NO in step S1003), the processing proceeds to step S1012. In the state of FIG. 8C, the printing state 802 of the image data 913 is “being printed”, and the processing proceeds to step S1004.

In step S1004, the print controller 122 causes the recording head 130 to perform a recording operation based on the print data by a predetermined distance in synchronization with the conveyance. After the completion of the recording operation by the predetermined distance, the processing proceeds to step S1005. Here, the recording operation is performed in units of 10 lines.

In step S1005, the main controller 111 updates the print completion distance stored in the RAM 114. In the case of performing the recording operation in units of 10 lines, the print completion distance is updated to 10 by the first update. The main controller 111 thereafter updates the print completion distance by adding 10 each time step S1004 is performed.

In step S1006, the main controller 111 checks whether to update the printing state 802 of each piece of image data. If all the pieces of image data have been checked (YES in step S1006), the processing proceeds to step S1003. If there is an unchecked piece of image data (NO in step S1006), the processing proceeds to step S1007. In the state of FIG. 8C, the processing proceeds to step S1007 to check whether to update the printing states 802 of the image data 911, 912, and 913.

In step S1007, the main controller 111 determines whether a cancel instruction for target image data is issued, with a piece of image data of which whether to update the printing state 802 is yet to be checked as the target image data. If a cancel instruction for the target image data is determined to be issued (YES in step S1007), the processing proceeds to step S1009. If no cancel instruction is determined to be issued (NO in step S1007), the processing proceeds to step S1008. Since the current print completion distance is 10 and the cancel instruction for the image data 913 is assumed to be issued when the print completion distance is 20, the processing proceeds to step S1008.

In step S1008, the main controller 111 compares the end position 804 of the target image data with the current print completion distance stored in the RAM 114. If the print completion distance is greater than or equal to the end position 804 of the image data (YES in step S1008), the processing proceeds to step S1009. If the print completion distance is less than the end position 804 of the image data (NO in step S1008), the processing proceeds to step S1010. The current print completion distance, 10, is less than the end position 804 of any of the pieces of image data. The processing therefore proceeds to step S1010.

In step S1010, the main controller 111 compares the start position 803 of the target image data with the current print completion distance stored in the RAM 114. If the print completion time is greater than or equal to the start position 803 of the target image data (YES in step S1010), the processing proceeds to step S1011. If the print completion distance is less than the start position 803 of the target image data (NO in step S1010), the processing proceeds to step S1006. The current print completion distance, 10, is greater than the start position 803 of the image data 913. The processing therefore proceeds to step S1011 when the image data 913 is the target image data.

In step S1011, the main controller 111 updates the printing state 802 of the target image data to “being printed”. The processing proceeds to step S1006. Since the printing state 802 of the image data 913 here is already “being printed”, the processing skips step S1011 and returns to step S1003 without updating the image data management table 800 from the state of FIG. 8C.

Suppose that the recording operation by the predetermined distance is then performed in step S1004, and the print completion distance is updated to 20 in step S1005. As described above, the cancel instruction for the image data 913 is issued when the print completion distance is 20. In such a case, the processing transitions from step S1007 to step S1009 when the image data 913 is checked.

In step S1009, the main controller 111 updates the printing state 802 of the image data 913 to “printed”. The processing proceeds to step S1006. FIG. 8D illustrates the image data management table 800 updated from the state of FIG. 8C.

After the image data 911 and 912 is checked, the processing proceeds to step S1003.

In the state of FIG. 8D, the image data 911 and 912 is on standby, and the image data 913 is printed. In step S1003, the main controller 111 therefore determines that there is no image data being printed (NO in step S1003), and the processing proceeds to step S1012 to stop the nesting printing. In such a manner, if there is no image data that is not to be cancelled and being printed upon the reception of a cancel instruction, the main controller 111 controls the nesting printing to stop at the position where the cancel instruction is accepted. The nesting printing can thus be stopped before image data that is not to be cancelled and on standby starts to be printed. Here, the print stop position is the position 901 in FIG. 9.

In step S1012, the print controller 122 causes the conveyance control unit 129 to stop conveying the sheet. The main controller 111 then ends the print processing. The processing proceeds to step S207.

In the present exemplary embodiment described above, if a cancel instruction for image data included in the nesting printing is issued, the nesting printing can be stopped before image data not to be cancelled starts to be printed. This can prevent paper and ink waste.

As a first modification of the present exemplary embodiment, if there is image data of which the printing state 802 is “on standby” in step S1012, the main controller 111 may continue conveying the sheet and print the image data on standby continuously.

As a second modification, if there is image data of which the printing state 802 is “on standby” in step S1012, the main controller 111 may notify the user that has given the image data on standby and yet to be printed that the image data will not be printed. In such a case, the image data management table 800 of FIG. 8 may include an item for storing the information about the users that has given the image data like the image data management table 600 of the second exemplary embodiment.

As a third modification, if there is image data of which the printing state 802 is “on standby” in step S1012, the processing may proceed to step S205 so that the main controller 111 lays out the image data on standby and yet to be printed again and resumes printing.

A fourth exemplary embodiment will be described. The foregoing exemplary embodiments have dealt with a case of printing a plurality of pieces of image data arranged in the main scanning direction of the sheet. The present exemplary embodiment deals with a case of printing a plurality of pieces of image data arranged not only in the direction orthogonal to the sheet conveyance direction but also in the sheet conveyance direction. Differences from the third exemplary embodiment will be mainly described below, and a description of similarities will be omitted.

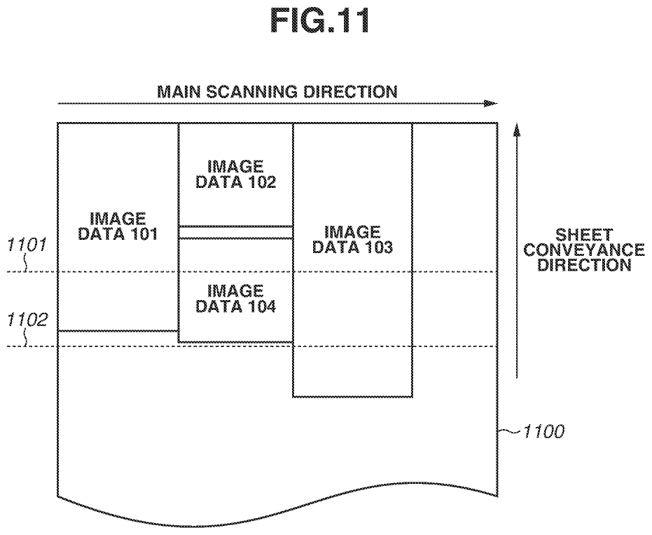

FIG. 11 is a diagram schematically illustrating pieces of image data laid out on a sheet. In the following description, suppose pieces of image data 101, 102, 103, and 104 are sequentially received from the host apparatus 190 within a predetermined time. During print layout, the pieces of image data 101, 102, and 103 are arranged on a sheet 1100 in the main scanning direction, and the image data 104 is located in the direction opposite to the conveyance direction of the image data 102 on the sheet 1100. The pieces of image data are then printed by nesting printing. The main controller 111 lays out the pieces of image data to be nesting printed so that the pieces of image data are efficiently arranged on the sheet 1100 based on the width of the sheet 1100 and the free space of the sheet 1100. In the present exemplary embodiment, suppose a cancel instruction for the image data 103 is accepted when the nesting printing is completed up to a position 1101.

The position 1101 is between the start position and the end position of the image data 104 in the sheet conveyance direction.

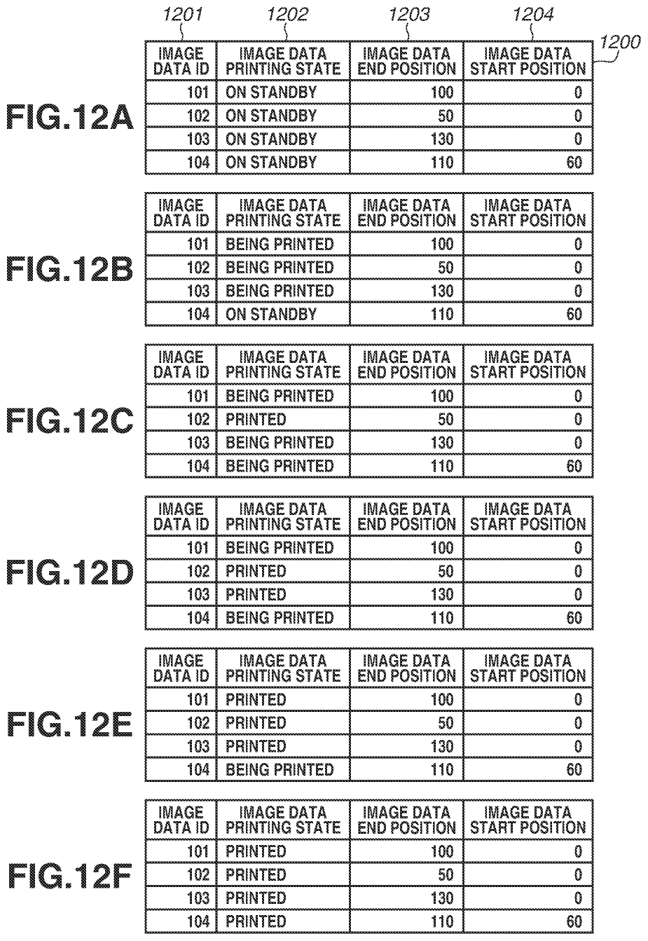

FIGS. 12A to 12F illustrate examples of an image data management table according to the present exemplary embodiment. An image data management table 1200 according to the present exemplary embodiment has a similar configuration to that of the image data management table 800 of FIG. 8. Items 1201, 1202, 1203, and 1204 of the image data management table 1200 according to the present exemplary embodiment correspond to the items 801, 802, 804, and 803 of the image data management table 800 of FIG. 8, respectively.

As with the first exemplary embodiment, the nesting printing according to the present exemplary embodiment is performed along the flowchart of FIG. 2. In the present exemplary embodiment, step S203 may be skipped and all pieces of image data received within a standby time may be subjected to nesting printing. FIG. 12A illustrates the state of the image data management table 1200 after the determination of the print layout in step S205.

As illustrated in FIG. 12A, as an image data end position 1203 and an image data start position 1204, information based on the print layout is stored. Step S206 is then performed. In the present exemplary embodiment, as with the third exemplary embodiment, the print processing of step S206 is performed based on the flowchart of FIG. 10.

The image data management table 1200 of FIG. 12A illustrates the printing states of the image data 101, 102, 103, and 104 immediately before the start of printing. The printing states 1202 of the image data 101, 102, 103, and 104 are all “on standby”. The main controller 111 then updates the printing states 1202 of the image data 101, 102, and 103 of which the image data start position 1204 has a value of 0 to “being printed”. FIG. 12B illustrates the image data management table 1200 updated from the state of FIG. 12A.

In the state of FIG. 12B, the printing states 1202 of the image data 101, 102, and 103 are “being printed”. The print controller 122 thus causes the recording head 130 to perform a recording operation based on the print data by a predetermined distance in synchronization with conveyance. The main controller 111 updates the print completion distance.

Suppose that the recording operation is thereafter performed in units of the predetermined distance, and the print completion distance is updated to 50. Since the end position 1203 of the image data 102 is 50 and agrees with the print completion distance, the main controller 111 updates the printing state 1202 of the image data 102 from “being printed” to “printed”. Suppose the print completion distance is then updated to 60. Since the start position 1204 of the image data 104 is 60 and agrees with the print completion distance, the main controller 111 updates the printing state 1202 of the image data 104 from “on standby” to “being printed”. FIG. 12C illustrates the state of the image data management table 1200 at that point in time.

Suppose a cancel instruction for the image data 103 is then issued when the print completion distance is 70. The main controller 111 updates the printing state 1202 of the image data 103 from “being printed” to “printed”. Here, the image data management table 1200 transitions from the state of FIG. 12C to the state of FIG. 12D.

Suppose the print completion distance is then updated to 100. Since the end position 1203 of the image data 101 is 100 and agrees with the print completion distance, the main controller 111 updates the printing state 1202 of the image data 101 from “being printed” to “printed”. Here, the image data management table 1200 transitions from the state of FIG. 12D to the state of FIG. 12E.

Suppose the print completion distance is then updated to 110. Since the end position 1203 of the image data 104 is 110 and agrees with the print completion distance, the main controller 111 updates the printing state 1202 of the image data 104 from “being printed” to “printed”. Here, the image data management table 1200 transitions from the state of FIG. 12E to the state of FIG. 12F.

In the state of FIG. 12F, the printing states 1202 of the image data 101, 102, 103, and 104 are all “printed”. The main controller 111 thus determines that there is no image data being printed (NO in step S1003), and the processing proceeds to step S1012 to stop the nesting printing. In such a manner, the main controller 111 controls the nesting printing to stop when the print completion distance reaches the end position 1203 of the image data 104. The printing stop position here is a position 1102 of FIG. 11.

According to the present exemplary embodiment described above, similar effects to those of the first exemplary embodiment can be obtained even if a plurality of pieces of image data to be nesting printed is arranged in the main scanning direction of the sheet and in the sheet conveyance direction.

As a modification of the present exemplary embodiment, if image data not to be cancelled includes image data being printed and image data on standby, the main controller 111 may control printing of the image data on standby not to be started.

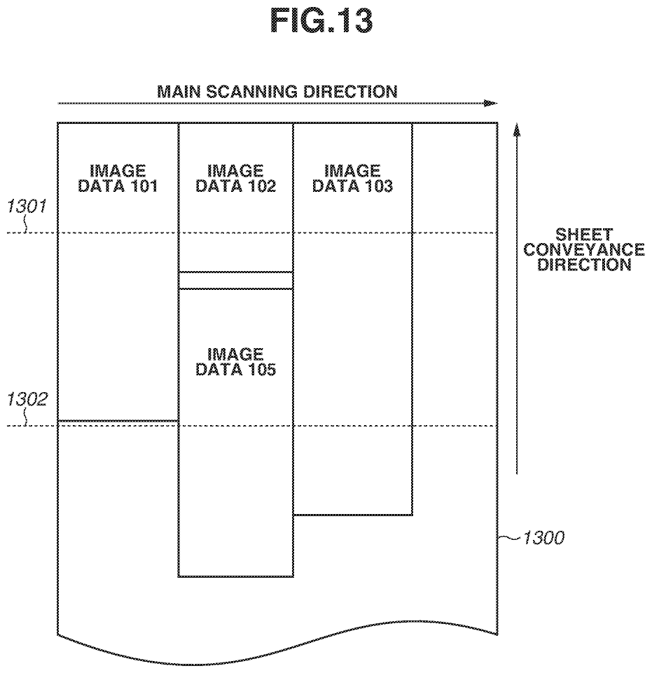

FIG. 13 is a diagram schematically illustrating pieces of image data laid out on a sheet in this modification. In the following description, suppose pieces of image data 101, 102, 103, and 105 are sequentially received from the host apparatus 190 within a predetermined time. During print layout, the pieces of image data 101, 102, and 103 are arranged on a sheet 1300 in the main scanning direction, and the image data 105 is located in the direction opposite to the conveyance direction of the image data 102 on the sheet 1300. The pieces of image data are then printed by nesting printing. In this modification, suppose a cancel instruction for the image data 103 is accepted when the nesting printing is completed up to a position 1301. The position 1301 is in front of the start position of the image data 105 in the conveyance direction.

In this modification, in the case where the pieces of image data 101, 102, and 105 not to be cancelled include the image data 101 and 102 being printed and the image data 105 on standby, the main controller 111 does not start to print the image data 105 on standby. Since the pieces of image data 101, 102, and 105 not to be cancelled include the image data 101 and 102 being printed, the processing proceeds from step S1003 to step S1004 to continue the nesting printing. By contrast, if the pieces of image data 101, 102, and 105 not to be cancelled include the image data 105 on standby and the printing state of the image data 105 is updated to “being printed” in subsequent step S1011 to further continue the nesting printing, the sheet and ink can be wasted. If the pieces of image data 101, 102, and 105 not to be cancelled include the image data 101 and 102 being printed and the image data 105 on standby, the main controller 111 therefore does not update the printing state of the image data 105 on standby to “being printed”. To exclude the image data 105 on standby from the nesting printing, the main controller 111 also deletes the information about the image data 105 on standby from the combined data to be nesting printed.

Suppose the print completion distance then reaches the end position of the image data 101. Since the printing states of the image data 101, 102, and 103 are all “printed”, the main controller 111 determines that there is no image data being printed, and stops the nesting printing. In such a manner, the main controller 111 stops the nesting printing when the print completion distance reaches the end position of the image data 101. The printing end position here is a position 1302 of FIG. 13. If the end position of image data not to be cancelled and on standby is in front of the end position of image data not to be cancelled and being printed in the conveyance direction, the main controller 111 may exclude the image data not to be cancelled and on standby from the processing for excluding image data from the nesting printing.

According to such a modification, image data not to be cancelled and being printed can be continuously nesting printed up to the end position while image data not to be cancelled and on standby is prevented from starting to be printed. This can prevent sheet and ink waste.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-062888, which was filed on Apr. 7, 2023 and which is hereby incorporated by reference herein in its entirety.

What is claimed is:

1. An image forming apparatus comprising:
one or more memories; and
one or more processors, wherein the one or more memories and the one or more processors are configured to:
control the image forming apparatus to perform printing of print data including a plurality of pieces of image data arranged in a direction orthogonal to a sheet conveyance direction;
accept a cancel instruction for at least one piece of the plurality of pieces of the image data during the printing of the print data; and,
in a case where a cancel instruction for first image data included in the plurality of pieces of the image data, is accepted, control the printing of the print data to stop at an end position of second image data included in the plurality of pieces of the image data, in the sheet conveyance direction of the print data, the second image data being image data not to be cancelled and being printed.

2. The image forming apparatus according to claim 1, wherein the one or more memories and the one or more processors are further configured to, in a case where there is a plurality of pieces of the second image data, control the printing of the print data to stop at an end position of one of the pieces of the second image data, the end position being a rearmost end position in the sheet conveyance direction of the print data.

3. The image forming apparatus according to claim 1, wherein the one or more memories and the one or more processors are further configured to, in a case where there is no second image data when the cancel instruction for the first image data is accepted, control the printing of the print data to stop at a position where the cancel instruction is accepted.

4. The image forming apparatus according to claim 1, wherein the one or more memories and the one or more processors are further configured to, in a case where there is third image data along with the second image data when the cancel instruction for the first image data is accepted, control printing of the third image data to not be performed, the third image data being image data not to be cancelled and on standby.

5. The image forming apparatus according to claim 1, wherein the one or more memories and the one or more processors are further configured to:
manage a printing state of each piece of the plurality of pieces of the image data;
in a case where the cancel instruction for the first image data is accepted, update the printing state of the first image data to a state other than being printed; and
determine a position to stop the printing of the print data at based on a length of image data of which the printing state is being printed in the sheet conveyance direction of the print data.

6. The image forming apparatus according to claim 5, wherein the one or more memories and the one or more processors are further configured to update the printing state of each piece of the plurality of pieces of the image data based on a distance up to which the printing of the print data is completed, and the length of the image data in the sheet conveyance direction of the print data.

7. The image forming apparatus according to claim 5, wherein the one or more memories and the one or more processors are further configured to manage the printing state of each piece of the plurality of pieces of the image data as on standby, being printed, and printed.

8. The image forming apparatus according to claim 1, wherein the one or more memories and the one or more processors are further configured to, in a case where there is the second image data when the cancel instruction for the first image data is accepted, control notification to a user that has issued the cancel instruction that the printing will not be immediately stopped.

9. The image forming apparatus according to claim 1, wherein the one or more memories and the one or more processors are further configured to generate the print data based on image data given by a user.

10. The image forming apparatus according to claim 9, wherein the one or more memories and the one or more processors are further configured to, in a case where there is the second image data when the cancel instruction for the first image data is accepted, control notification to a user that has given the second image data that a cancel instruction is issued for other image data included in the print data.

11. The image forming apparatus according to claim 5, wherein the one or more memories and the one or more processors are further configured to:
manage a start position and an end position of each piece of the plurality of pieces of the image data in the sheet conveyance direction of the print data; and
control the printing of the print data to stop at the end position of a piece of the plurality of pieces of the image data of which the printing state is being printed in the sheet conveyance direction of the print data.

12. The image forming apparatus according to claim 11, wherein the one or more memories and the one or more processors are further configured to, in a case where a distance up to which the printing of the print data is completed reaches or exceeds the start position of the image data, update the printing state of the image data from on standby to being printed, and in a case where the distance up to which the printing of the print data is completed reaches or exceeds the end position of the image data, update the printing state of the image data from being printed to printed.

13. The image forming apparatus according to claim 1, wherein the one or more memories and the one or more processors are further configured to generate the print data based on image data given by a user; and,
in a case where there is third image data when the cancel instruction for the first image data is accepted, control notification to a user that has given the third image data that the third image data will not be printed in the print data in progress, the third image data being image data not to be cancelled and on standby.

14. The image forming apparatus according to claim 1, wherein the one or more memories and the one or more processors are further configured to arrange two or more of the plurality of pieces of the image data in the direction orthogonal to the sheet conveyance direction and in the sheet conveyance direction.

15. An image forming method comprising:
printing print data including a plurality of pieces of image data arranged in a direction orthogonal to a sheet conveyance direction;
accepting a cancel instruction for at least one piece of the plurality of pieces of the image data during the printing of the print data; and,
in a case where a cancel instruction for first image data, of the image data, is accepted, the printing of the print data is controlled to stop at an end position of second image data, of the image data, in the sheet conveyance direction of the print data, the second image data being image data not to be cancelled and being printed.

16. A non-transitory computer-readable medium storing computer-executable instructions that, when executed by an image forming apparatus, cause the image forming apparatus to execute an image forming method, the image forming method comprising:
printing print data including a plurality of pieces of image data arranged in a direction orthogonal to a sheet conveyance direction;
accepting a cancel instruction for at least one piece of the plurality of pieces of the image data during the printing of the print data; and,
in a case where a cancel instruction for first image data, of the image data, is accepted, the printing of the print data is controlled to stop at an end position of second image data, of the image data, in the sheet conveyance direction of the print data, the second image data being image data not to be cancelled and being printed.
